(19) United States
(12) Patent Application Publication
(10) Pub. No.: US 2007/0082817 A1
(43) Pub. Date: Apr. 12, 2007

(54) Photomorphic building materials

(76) Inventor: Blane M. Kivley, Fair Oaks, CA (US)

Correspondence Address: BRADLEY P. HEISLER;HEISLER & ASSOCIATES, 3017 DOUGLAS BOULEVARD, SUTIE 300, ROSEVILLE, CA, 95661, US

(21) Appl. No.: 11/541,091

(22) Filed: Sep. 29, 2006

Related U.S. Application Data
(60) Provisional application No. 60/726,064, filed on Oct. 11, 2005.

(51) Int. Cl. B41M 5/24

(52) U.S. Cl. 503/227

(57) ABSTRACT

A photomorphic building material is provided which provides a dynamic visual appearance for the building material. A base material is provided which is attachable to surfaces of a residential structure or other structure, or otherwise affixed within the structure. At least one surface of the base material has a photomorphic layer coupled thereto. This photomorphic layer has a color and/or transparency/opacity change in response to environmental conditions. Conditions for triggering such change include temperature changes, light changes, pressure changes and other conditions. When the conditions change, the appearance of the photomorphic layer changes so that a dynamic visual display is provided. An image layer can be provided along with the photomorphic layer so that the image is selectively revealed by changes in the photomorphic layer. A protective layer can also be provided to protect the photomorphic layer and the image layer.

### FIELD OF THE INVENTION

The following invention relates to building materials which are adapted to be affixed within buildings such as residential and commercial structures to provide a desired decorative appearance for surfaces of the structure and to meet functional criteria desired for the surfaces. More particularly, this invention relates to building materials which exhibit a change in appearance responsive to changes in environmental conditions (natural or manmade) surrounding the building material.

### BACKGROUND OF THE INVENTION

Residential structures and other buildings are formed from a wide variety of different materials to satisfy the functional criteria for the different parts of the structure and to provide a desirable decorative appearance. While some building materials are adapted to be buried within walls, floors or other portions of the structure or are covered with other building materials, such that their appearance is not important, other building materials reside on surfaces of the structure or away from surfaces of the structure, where they are visible by individuals or adjacent the structure, either inside or outside.

Most individuals are highly visually perceptive and draw significant impressions and other information from what is seen on surfaces forming a structure. Individuals use the appearance of the surfaces of the building for both functional purposes and for decorative enjoyment purposes. With regard to function, surfaces are selected from materials which are transparent or opaque, depending on whether it is desirable that individuals be allowed to see through the surfaces (i.e. windows vs. walls). Surfaces can be provided with varying degrees of light reflectivity, to make it easier for individuals to see in portions of the residential structure where visibility is important.

Other surfacing materials for residential structures are selected to have a visual appearance which enhances the enjoyment of individuals adjacent the structure. Colors, textures, patterns and other visually perceptible details of the surfacing materials can be crafted to maximize the desired emotional effect upon the viewer.

Heretofore, building materials for surfaces of residential structures have essentially completely been static in their visual appearance. The designer of the residential structure must select one visual appearance for the surface and then be satisfied with that appearance until a major redesign is pursued and the surfacing materials are removed and replaced. Skilled designers can in some instances provide a very limited degree of change in appearance of surface building materials in some instances. For instance, by making lighting adjustable, some materials will change significantly in appearance depending on how the lighting is adjusted. Also, some appliances, such as cook tops, change in color responsive to heat, such that a user can readily determine that the cook top is dangerously hot.

In general, however, surface building materials remain static in visual appearance after they are installed. Such static visual appearance has decreased to some extent the flexibility experienced by designers in creatively providing interesting and desirable visual impressions for the surfaces of the structure. Accordingly, a need exists for building materials, and particularly surfacing materials which can be used in the residential structure or other structure, and which change in appearance responsive to environmental conditions surrounding the building material, such that the building material is “photomorphic.” Such surfacing materials include, but are not limited to, paint, stucco, plaster, texturing material, grout, tile, light fixtures, plumbing fixtures, wall panels, wallpaper, flooring, fabrics, windows, doors, partitions, counter tops and access panels. Such photomorphic building materials would beneficially be able to change in color or change in transparency/opacity so that a variety of interesting and dynamic visual appearances can be provided by the building material.

### SUMMARY OF THE INVENTION

With this invention, a photomorphic building material is provided which can be affixed to a residential structure, such as tiles on a floor or walls of the residential structure, or alternatively as portions of other fixtures away from surfaces within the residential structure. The photomorphic building material includes a base material which is adapted to be affixed within the residential structure. This base material is preferably a known building material whose functional characteristics are well known and for which installation techniques have been well developed, such that tradesmen can install the building materials without significant additional training. For instance, the base material can be in the form of ceramic tiles or glass tiles which can utilize known installation techniques for attachment of the base material to floors, walls or other surfaces of the residential structure.

A photomorphic layer is coupled to this base material in one or more of a variety of different ways. When the base material is itself opaque, the photomorphic layer would be placed upon a side of the base material which is oriented to face in a direction toward where a viewer would view the surface upon which the base material is fixed, and opposite a surface of the base material which is provided for attachment to the surface. This top surface of the base material would be provided with the photomorphic layer through techniques such as painting, printing, gluing, spraying, dipping, depositing or otherwise coupling the photomorphic layer onto this top surface. If needed, a protective layer can additionally be provided on top of the photomorphic layer to protect the photomorphic layer from damage due to contact or other potentially damaging influences.

If the base material is transparent, such as a glass tile, the photomorphic layer can be placed adjacent a bottom surface opposite the top surface, so that the photomorphic layer is in fact viewed through the base material, rather than upon the base material. A portion of the photomorphic layer in such an arrangement might be coated with an attachment layer, if necessary, to facilitate attachment of the transparent base material through the photomorphic layer onto an underlying surface of the structure.

The photomorphic layer is formed of a material which changes in appearance responsive to environmental changes surrounding the building material having the photomorphic layer. The change in appearance can either be a change in color, either between two different colors or through a series of different colors, or can be a change in transparency/opacity experienced by the photomorphic layer. This change in opacity can also be coupled with a color change, such that the photomorphic layer changes from a particular color to transparent and back to a particular color in response to changes in the environment surrounding the building material.

The environmental conditions to which the photomorphic layer responds can be changes in temperature, changes in surface pressure or changes in light incident upon the surface of the photomorphic layer or other environmental changes, either directly or through a protective layer or through the building material should it be transparent. Thus, as the environment changes the appearance of the building material changes; through changes occurring in the photomorphic layer.

The photomorphic layer can cover an entire surface of the base material or can be selectively applied on only portions of the base material. Additionally, an image layer can be provided above or below the photomorphic layer so that this image layer can be selectively made visible or disappear as the photomorphic layer undergoes transparency/opacity changes, or this image layer can have a background behind the image change through changes in the photomorphic layer, but with the image always being visible.

### OBJECTS OF THE INVENTION

Accordingly, a primary object of the present invention is to provide a dynamic visual appearance for surfaces and fixtures associated with a residential structure.

Another object of the present invention is to provide further options for residential structure designers and designers of similar structures which include surfacing materials and other fixtures which have a dynamic appearance responsive to environmental conditions.

Another object of the present invention is to provide fixtures for residential structures which change in appearance to indicate to a viewer that a change in the environment has occurred, such as that water within a tub is warm.

Another object of the present invention is to provide an enhanced degree of interest and desirability of appearance for visible surfaces of a residential structure.

Another object of the present invention is to both provide functional performance and desirable appearance in a variety of different building materials, by providing the building materials with a dynamic visual appearance.

Other further objects of the present invention will become apparent from a careful reading of the included drawing figures, the claims and detailed description of the invention.

### BRIEF DESCRIPTION OF THE DRAWINGS

FIG. 1 is a perspective view of a photomorphic building material according to this invention, and with a transparent base material having a photomorphic layer beneath the base material.

FIG. 2 is a flow chart identifying the steps associated with constructing the photomorphic building material according to this invention as depicted in FIG. 1.

FIGS. 3-5 are a sequence of perspective views revealing how an image can be made sequentially more and more visible as a photomorphic layer on top of an image layer changes from being opaque to being transparent.

FIGS. 6-8 are a series of perspective views illustrating how a photomorphic building material can have an image printed with photomorphic material so that the photomorphic material transitions from being visible to being invisible in response to an environmental condition, so that the image formed of this photomorphic material is progressively caused to disappear.

FIG. 9 is a perspective view of an alternative photomorphic building material which can have a base material that is either opaque or transparent, and with the photomorphic layer on top of the base material, and with an optional image layer and protective layer also provided.

FIG. 10 is a flow chart revealing the steps in manufacture of the photomorphic building material of this invention according to FIG. 9.

### DESCRIPTION OF THE PREFERRED EMBODIMENT

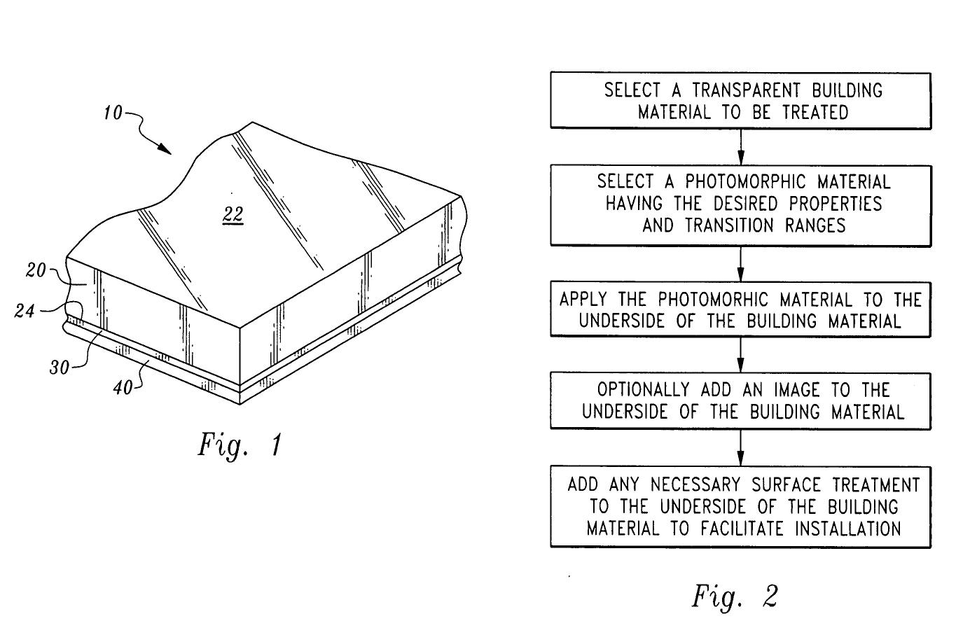

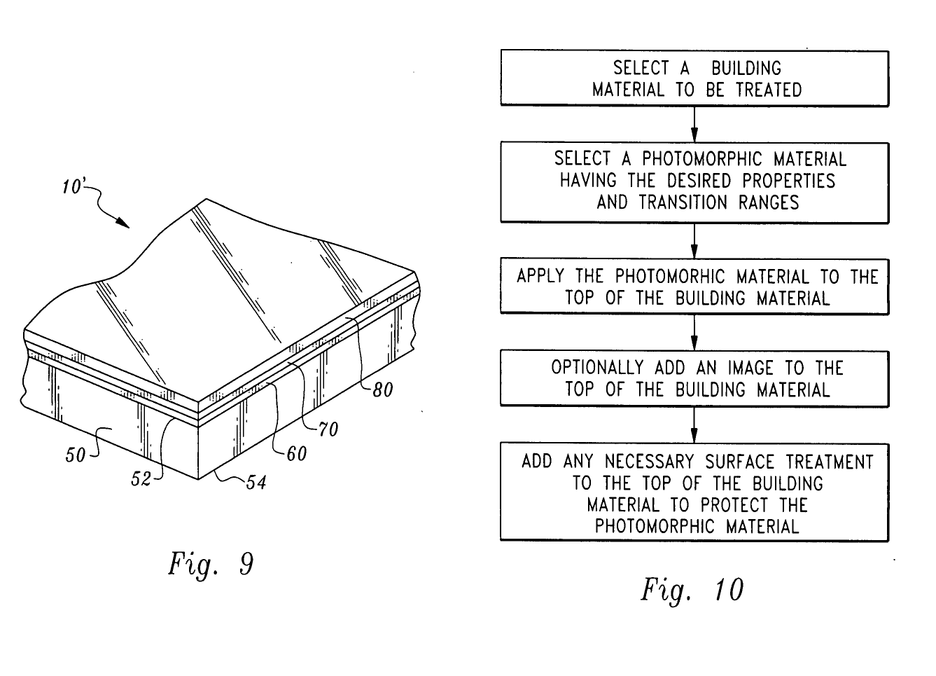

Referring to the drawings, wherein like reference numerals represent like parts throughout the various drawing figures, reference numeral 10, 10′ is directed to a photomorphic building material (FIGS. 1 and 9) which can be affixed within a residential structure or other building and which exhibits a dynamic appearance. The photomorphic building material 10, 10′ includes a photomorphic layer 30, 70 coupled to a base material 20, 50 in a manner which allows the photomorphic layer 30, 70 to be viewed from a side of the photomorphic building material 10, 10′ closest to a top surface 22 or top 52 of the base material 20. The photomorphic building material 10, 10′ thus provides a changing dynamic appearance responsive to environmental conditions surrounding the photomorphic building material 10, 10′.

In essence, and with particular reference to FIGS. 1 and 9, the basic details of the photomorphic building material 10, 10′ are described. The photomorphic building material 10 (FIG. 1) includes a base material 20 which, in the embodiment of FIG. 1, is at least partially transparent. A photomorphic layer 30 is provided adjacent a bottom surface 24 of the base material 20. The photomorphic layer 30 is thus visible through the base material 20 and from a side of the base material 20 closest to the top surface 22. An image layer 40 is optionally provided below the photomorphic layer 30, or alternatively between the photomorphic layer 30 and the base material 20. The photomorphic layer 30 is configured to change in color or opacity responsive to environmental conditions, such as changes in temperature or changes in light radiation striking the photomorphic layer 30.

In a variation on the photomorphic building material 10 of FIG. 1, an opaque base material 50 (FIG. 9) can be utilized to form an alternative photomorphic building material 10′. When utilizing an opaque base material 50, an image layer 60 would typically be provided adjacent a top 52 of the base material 50. A photomorphic layer 70 would then be provided on top of the image layer 60. Alternatively, the image layer 60 and photomorphic layer 70 can be switched. An optional protective layer 80 can be provided at a highest level above the base material 50 to protect the photomorphic layer 70 and or the image layer 60 from damage. The photomorphic building material 10, 10′ can then be affixed to a residential structure, such as providing a portion of flooring, wall treatment, or on other surfaces of the residential structure, or fixtures contained within the residential structure. When environmental conditions change, such as changes in temperature or changes in light, the photomorphic layer 30, 70 is altered so that the appearance of the photomorphic building material 10, 10′ is changed.

More particularly, and with specific reference to FIG. 1, details of the photomorphic building material 10 according to a preferred embodiment are described. In this embodiment, the photomorphic building material 10 is formed of an at least partially transparent base material 20, primarily. This base material 20 would most typically be in the form of a glass tile or other glass fixture configured to be attached to a surface or other structure utilizing known building techniques. The transparent building material 20 could alternatively be transparent acrylic, or other transparent plastic or other hydrocarbon material to suit the needs of the particular design being implemented.

This base material 20 could be in the form of a thin square tile, or could be rectangular, or have some form of irregular shape but still with a generally thin form. Alternatively, the base material 20 could be a large sheet of partially transparent material, such as a glass shower door, a mirror, a glass cabinet door or room door, a window, or other large planar surface. As a still further alternative, the transparent material could be non-planar, such as the surface of a tub, sink catch basin, light diffuser for a light fixture, table top, hearth, mantel, picture frame, or any other transparent structure for which the design effect is sought.

The base material 20 preferably has two large primary surfaces including a top surface 22 and a bottom surface 24. The top surface 22 is that surface which is closest to a region where a viewer would most typically be viewing the photomorphic building material 10. Thus, the top surface 22 would generally be facing into the room in which the photomorphic building material 10 is installed. A bottom surface 24 is provided opposite the top surface 22 which would typically be generally parallel with the top surface 22 and spaced from the top surface 22 by a thickness of the base material 20. In one alternative, the photomorphic building material 10 can be situated where it is visible from both sides, such that the distinction between the top surface 22 and bottom surface 24 relative to the orientation of the room is insignificant. For instance, in the case of a shower door, both the top surface 22 and bottom surface 24 of the base material 20 would face horizontally into directions where the photomorphic building material 10 would be viewed (inside and outside the shower).

The photomorphic layer 30 is preferably provided directly adjacent the bottom surface 24 of the transparent base material 20. This photomorphic layer 30 can thus be viewed through the transparent base material 20 by a viewer located in the region which is faced by the top surface 22 of the transparent base material 20. Particular details of the photomorphic layer 30 can vary, and are described in detail below. The photomorphic layer 30 is coupled to the bottom surface 24 of the transparent base material 20, such as by painting the photomorphic layer 30 as a liquid onto the bottom surface 24 of the transparent base material 20, and allowing the photomorphic layer 30 to harden into a solid and remain attached to the bottom surface 24 of the base material 20. Alternatively, the photomorphic layer 30 could be a solid layer and could be attached through utilizing a separate adhesive, or through utilizing mechanical fasteners such as screws, nails, rivets or the like, or through use of edge structures, such as clamps, to hold the photomorphic layer 30 adjacent the bottom surface 24 of the transparent base material 20.

While the photomorphic building material 10 could be comprised of only the transparent base material 20 and the photomorphic layer 30, the photomorphic building material 10 can be modified to additionally include an image layer 40. When such an image layer 40 is provided, in one form of the invention the image layer 40 can be provided as a portion of the photomorphic layer 30. For instance, the photomorphic layer 30 can be provided over only portions of the bottom surface 24, rather than over the entire bottom surface 24, with a boundary of the photomorphic layer 30 defining a silhouette in the form of a recognizable image.

The image layer 40 is most typically an entirely separate layer which would preferably be located below the photomorphic layer 30 and spaced from the bottom surface 24 of the transparent base material 20. The image layer 40 could be viewable from either side, or only viewable from beyond the top surface 22 through the transparent base material 20. The image layer 40 could be a photograph, a silhouette, some form of mosaic image comprised of separate pieces having different colors or shapes, or any other visually perceptible image, most typically, but not necessarily, providing some recognizable image when viewed by an individual within the room faced by the photomorphic building material 10.

When the photomorphic layer 30 is transparent, the image layer 40 can be viewed through the transparent base material 20. When the photomorphic layer 30 is opaque, the image layer 40 is partially or entirely blocked from view. The photomorphic layer 30 can alternatively be over only a portion of the bottom surface 24, so that the photomorphic layer 30 and the image layer 40 do not overlap, or only partially overlap, so that only portions of the image layer 40 are occluded when the photomorphic layer 30 is opaque. In at least one alternative, the image layer 40 can also be provided of photomorphic material which is responsive in a different way to conditions in the surrounding environment, so that both the photomorphic layer 30 and the image layer 40 are responding dynamically, but to different environmental stimuli (such as temperature and light), or different ranges of the same stimuli (such as a lower temperature transition for one layer and a higher transition temperature for another layer), so that a dynamic image with multiple degrees of freedom can be created.

The photomorphic building material 10 can be installed in the same manner as other similar base materials formed of similar elements, and having similar surfaces. If necessary, an installation layer can be provided below the image layer 40 with the installation layer providing the necessary degree of friction, adhesive bonding properties, fastener engagement structures, or other features to facilitate installation of the photomorphic building material 10 adjacent a surface or otherwise where desired.

While the image layer 40 is preferably located below the photomorphic layer 30, this arrangement could be switched. In particular, the image layer 40 could be located above the photomorphic layer 30, but not entirely covering the surface. With such an arrangement, the image layer 40 would always be visible through the transparent base material 20. However, the photomorphic layer 30 would provide a form of backdrop behind the image layer 40 with portions of the photomorphic layer 30 transitioning from one color to another, or transitioning from opaque to transparent so that a dynamic backdrop is provided behind the image layer 40.

In the case where the transparent base material 20 is to be viewed from both sides, the photomorphic layer 30 can be providing a backdrop for the image layer 40 when the transparent base material 20 is viewed from one side and the photomorphic layer 30 can be selectively occluding or revealing the image layer 40 from the opposite side of the transparent base material 20. For instance, a shower door could be constructed with a glass base material 20 and with the photomorphic layer 30 adjacent the bottom surface 24 and with the image layer 40 adjacent the photomorphic layer 30. From one side (for instance within the shower) the image layer 40 would be occluded from view until the photomorphic layer 30 responds to the environment in a way which allows the photomorphic layer 30 to transition to a transparent form so that image layer 40 can be viewed. From outside of the shower, this same glass door would show the image layer 40 with the photomorphic layer 30 as a backdrop. When this transition environmental condition occurs, the photomorphic layer 30 would transition to transparent so that the image layer 40 would be viewed in greater contrast with a transparent backdrop. Thus, a desirable and dynamic visual appearance can be provided which is different on either side of the transparent base material 20.

A particular summary of the process in forming the photomorphic building material 10 is shown in FIG. 2. In particular, initially a transparent building material is selected having the desired functional and visual characteristics. A photomorphic material is then selected to comprise the photomorphic layer. This photomorphic material is selected to have the colors desired as well as to have the desired transition ranges and the desired type of transition responsive to environmental conditions.

For instance, the photomorphic material can be a thermochromatic ink which transitions from a particular color when opaque to transparent responsive to changes in temperature in the surrounding environment. In such a case, the photomorphic material would be selected as a thermochromatic ink which has the color desired and to have the transition temperature desired so that the photomorphic material transitions at the desired temperature from opaque to transparent. This photomorphic material that has been selected is then coupled to the underside of the building material, such as adjacent the bottom surface 24. Optionally, an image is then provided adjacent the photomorphic layer 30 to form the image layer 40. Finally, any necessary surface treatment is coupled to the underside of the photomorphic building material 10 to facilitate installation. The thermochromatic ink can be applied to the surface or mixed into a thin coating or a thick coating or mixed into a material which at least partially hardens into the building material itself. For instance, the ink could be mixed into various types of paints, slurries, plasters, epoxies, powder coatings, caulkings, rubberized materials, or clay materials, that when hardened or dried impart the photomorphic effect upon the building material.

In addition to thermochromatic inks, or other thermochromatic materials, the photomorphic material can alternatively be photochromatic so that rather than being responsive to temperature changes, the photomorphic layer changes in response to the presence or absence of light striking the photomorphic layer 30. Another alternative is to provide the photomorphic layer as a liquid crystal layer which transitions between different colors responsive to temperature or other environmental stimuli, such as pressure. Also, multiple photomorphic layers of similar or different types can be used together on the building material.

Particular materials which are known to have a thermochromatic effect and which are suitable for coupling to the base material 20 include products sold under the name “Thermochromatic Inks” by Chromatic Technologies, Incorporated of Colorado Springs, Colo.

Particular photochromatic materials which are known to have a photochromatic effect and which are suitable for coupling to the base material 20 include products sold under the name “Photochromatic Inks” by Chromatic Technologies, Incorporated of Colorado Springs, Colo.

Particular liquid crystal materials which are known to have a liquid crystal effect and which are suitable for coupling to the base material 20 include liquid crystal materials provided by Liquid Crystal Resources Hallcrest of Glenview, Ill.

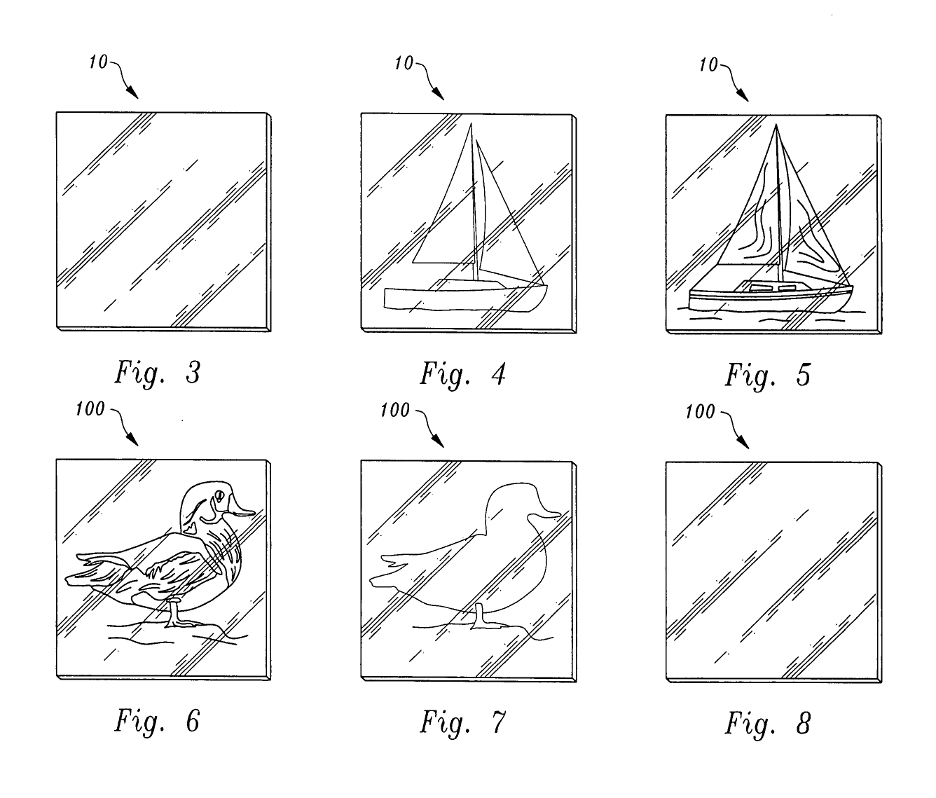

With particular reference to FIGS. 3-8, a visual depiction is provided of different ways that the photomorphic building material 10 can function, or an optional variation of the photomorphic building material 100 can function according to this invention. In particular, and with reference to FIGS. 3-5, a photomorphic building material 10 is provided which has a photomorphic layer 30 between the transparent building material 20 and the image layer 40. The photomorphic layer 30 is of a type which is opaque at a first temperature and transitions to being transparent at a second temperature. As shown in FIG. 3, the photomorphic layer 30 is opaque because the photomorphic building material 10 is at the first opaque temperature for the photomorphic layer 30. Hence, the image layer cannot be seen.

As shown in FIG. 4, the temperature is transitioning towards the second temperature, so that the photomorphic layer 30 is beginning to transition from being opaque to being partially transparent. Hence, the image layer 40 can be partially viewed through the photomorphic layer 30 and through the transparent base material 20 of the photomorphic building material 10.

When the photomorphic layer 30 has fully experienced the second temperature, the photomorphic layer 30 is substantially completely transparent and the image layer 40 can be clearly seen through the transparent building material 20 (FIG. 5). In the case of FIGS. 3-5, the photomorphic layer 30 covers the entire bottom surface 24 (FIG. 1) of the transparent base material 20. The image layer 40 is in the form of a picture of a sailboat. This sailboat image cannot be seen until the photomorphic layer 30 which covers the entire photomorphic building material 10 transitions to becoming transparent. It will be understood that if the photomorphic layer 30 only covered a portion of the surface of the photomorphic building material 10, portions of the image layer 40 would always be visible. For instance, the photomorphic layer 30 could be provided in the form of birds surrounding the sailboat, or clouds, or a sun, with these additional details of the overall picture being visible when the photomorphic layer 30 is opaque and disappearing when the photomorphic layer 30 is transparent.

With particular reference to FIGS. 6-8, an alternative transitional dynamic display is provided through alternative photomorphic building materials 100. In this case, the image itself is formed of photomorphic material. Initially, as shown in FIG. 6, the photomorphic material is opaque, so that the photomorphic layer 30 (FIG. 1) can be seen. As the temperature changes, or other environmental conditions change, the photomorphic layer 30 transitions toward being transparent, so that the image formed with the photomorphic material begins to disappear (FIG. 7). Finally, (as depicted in FIG. 8), the image formed out of the photomorphic material completely disappears when the second environmental condition has been reached. In this example of FIGS. 6-8, the final display (FIG. 8) is transparent, or revealing the appearance of the base material, rather than being fully covered with the opaque photomorphic layer 30 as depicted in FIG. 3.

With particular reference to FIG. 9, an alternative photomorphic building material 10′ is described which is particularly useful with opaque base material 50. In particular, the opaque base material 50 can have a similar form to that of the transparent base material 20, but only differs in that it is non-transparent. Alternatively, the arrangement of the alternative photomorphic building material 10′ of FIG. 9 could also be utilized upon transparent based material.

The opaque based material 50 includes a top 52 opposite a bottom 54. An image layer 60 is provided adjacent the top 52. A photomorphic layer 70 is provided on top of the image layer 60. The photomorphic layer 70 and image layer 60 can alternatively be switched. A final protective layer is optionally provided on top of the photomorphic layer 70 to protect the photomorphic layer 70 and/or the image layer 60 from damage. This arrangement is particularly well suited for ceramic tiles or other fixtures such as sink catch basins or tubs which are formed from ceramic materials, cast iron, fiberglass, porcelain or other materials, but which are typically not transparent. In this arrangement, the image layer and/or the photomorphic layer provide a dynamic display which is located on top of the opaque base material 50. Other details of this alternative photomorphic building material 10′ are similar to those of the embodiment of FIG. 1 described in detail above.

To construct the alternative photomorphic building material 10′, steps are followed as depicted in FIG. 10. Initially, a building material is selected having the desired functional characteristics and appearance. Next, an appropriate photomorphic material is selected that has the desired properties and environmental condition transition ranges (such as various different transition temperature ranges) to function as desired and to have the desired appearance. This photomorphic material is then applied to the top of the building material. An image can optionally be provided between the photomorphic material and the building material, or on top of the photomorphic material. Finally, any necessary surface treatment is provided on top of the highest layer of either the photomorphic material or the image layer to protect the photomorphic material and/or the image from damage.

This invention is further illustrated through the following specific examples.

### EXAMPLE 1

A photomorphic building material similar to that shown in FIG. 1 is provided. The base material is at least partially transparent glass. A photomorphic layer is provided adjacent the glass base material. The particular photomorphic material is a complete layer of thermochromatic ink coating the bottom surface of the glass forming the base material. The particular thermochromatic ink is thermochromatic epoxy screen ink (provided by Chromatic Technologies, Incorporated of Colorado Springs, Colo.) which is a dark blue color below 80° F. transitioning to a lighter blue and then being fully transparent at 88° F. An image layer is provided in the form of a vinyl silhouette of an animal, such as a dolphin. The vinyl is a very dark or black color and is attached to the thermochromatic ink through the use of an adhesive.

A series of similar glass tiles are mounted in a horizontal ring surrounding a shower through the utilization of a hard substrate suitable for mounting ceramic or glass tile thereto, and providing a standard mortar bed upon this backing material and setting the glass tile of this example into this mortar bed. After hardening, grout is provided between adjacent similar glass tiles.

When the shower is not in use and the temperature within the home is below 80° F., the tiles of this example are an opaque blue color without the silhouette of the dolphin being visible. When the water is turned on, and if the water is above 84° F., as it heats the air within the shower and strikes the wall within the shower, the thermochromatic ink begins to transition from opaque toward transparent so that the silhouette of the dolphins begins to appear. After the water has been running in the shower for a few minutes, the walls have heated sufficiently through the glass so that the thermochromatic ink has completely transitioned to transparent and all of the dolphin silhouettes are visible. When the shower is turned off and as the air slowly returns back to room temperature through air circulation within the house, the thermochromatic ink slowly transitions back to opaque and the dolphin silhouettes gradually disappear. The particular silhouettes provided for the images can be any desired silhouette, or can be a photograph, such as an ink jet printer photograph on paper that is laminated and then bonded with a transparent adhesive to the photomorphic layer.

### EXAMPLE 2

In this example, the base material is planar sheet material, such as wall board (i.e. gypsum board or its substitutes) which is a very dark blue or black color. An image layer is provided upon the top of this base material. The image in this particular case is a series of space images, such as stars, moons, comets, planets or other space images. These images are made of a light yellow or other color ink provided onto the base material. A photomorphic layer is provided over the top of the image layer completely covering the opaque ceramic base material. The photomorphic layer is photochromatic material, such as photochromatic inks (provided by Chromatic Technologies, Incorporated of Colorado Springs, Colo.) which transitions from opaque in high light conditions to transparent in low light conditions. The base material is in the form of a series of large sheets that are bonded to upper portions of the walls and the ceiling of a bedroom. The method for bonding is similar to that provided for standard wallboard (i.e. screws). In high light conditions, the photochromatic layer is opaque. This photochromatic layer is provided with a medium to light blue color so that the ceiling and walls of the room have a color similar to that of the daytime sky when light is coming into the room through windows or when a high degree of light is provided from artificial sources within the room. When no light is coming through windows and artificial light sources are dimmed sufficiently to cause an amount of light incident upon the photochromatic material to drop below the threshold level, the photochromatic material transitions from being opaque and light blue in color to being transparent. When this photochromatic layer is transparent, the dark underlying surface and the light yellow stars and other related images become visible. The bedroom thus exhibits a sky appearance similar to that which in naturally occurring outside of the house at the same time.

### EXAMPLE 3

A photomorphic building material is provided in the form of a transparent base material with a photomorphic layer adjacent the bottom surface. The photomorphic layer is formed of liquid crystal material such as liquid crystal materials (provided by Liquid Crystal Resources Hallcrest of Glenview, Ill.) having the transition temperature characteristics associated with this material and as described in more detail above. The glass tiles are in the form of large glass bricks which are joined together utilizing appropriate mortar or other bonding agents. The glass brick has a somewhat distorting effect on light passing therethrough, and in this example no image layer is provided. As temperature changes occur within the room a variety of different colors are displayed by the photomorphic layer and are visible through the transparent base material to provide a dynamic and colorful display.

### EXAMPLE 4

This example is similar to EXAMPLE 1 except the image layer is placed adjacent the bottom surface of the transparent glass base material and the thermochromatic material is provided below the image layer. Hence, the silhouettes of the dolphin or other image are always visible through the transparent glass base material within the shower. As the temperature increases, the thermochromatic material behind the image layer transitions from opaque to transparent. Thus, the thermochromatic material provides a background for the silhouette of the dolphins or other images until the transition temperature is reached, and then the background for the silhouette or other images fades to transparent. If desired, a different color layer (i.e. pink) can be provided so that the background is transitioning from the color of the thermochromatic material (i.e. blue) when opaque to the color of a further underlying layer when the thermochromatic layer becomes transparent. The backdrop for the silhouettes is thus changeable in response to the temperature occurring within the shower (i.e. blue when cool and pink when hot).

### EXAMPLE 5

In this example, an opaque base material in the form of a bathtub is provided. The top of the opaque ceramic base material has images stenciled thereon with paint in the form of fish. A thermochromatic layer is provided on top of this image layer entirely coating the top of the bathtub. Before water is placed in the bathtub, the temperature is sufficiently low that the thermochromatic ink is opaque and the entire bathtub has the color of the thermochromatic ink.

When hot water is placed in the bathtub, the thermochromatic ink transitions from opaque to transparent, revealing the images of the fish underlying the thermochromatic layer. The fish can thus be seen when the hot water is in the tub. A protective layer is provided in the form of a thin layer of transparent acrylic resin to protect the thermochromatic ink and the painted image of the fish underneath the thermochromatic ink.

In each of these examples, the base material, the photomorphic layer, and the image layer can be substituted for other variations where appropriate in accordance with details for these layers described above.

This disclosure is provided to reveal a preferred embodiment of the invention and a best mode for practicing the invention. Having thus described the invention in this way, it should be apparent that various different modifications can be made to the preferred embodiment without departing from the scope and spirit of this invention disclosure. When structures are identified as a means to perform a function, the identification is intended to include all structures which can perform the function specified. When structures of this invention are identified as being coupled together, such language should be interpreted broadly to include the structures being coupled directly together or coupled together through intervening structures. Such coupling could be permanent or temporary and either in a rigid fashion or in a fashion which allows pivoting, sliding or other relative motion while still providing some form of attachment, unless specifically restricted.

What is claimed is:

1. A photomorphic building material, comprising in combination:
a base material adapted to be installed within a residential structure;
said base material having at least one side adapted to be oriented for viewing by individuals adjacent the residential structure; and
a photomorphic layer coupled to said base material, said photomorphic layer visible from said viewing side of said base material, said photomorphic layer adapted to change in appearance in response to changes in environmental conditions experienced by said photomorphic layer.

2. The photomorphic building material of claim 1 wherein said photomorphic layer is located in front of said at least one side of said base material adapted for viewing.

3. The photomorphic building material of claim 2 wherein an image layer is interposed between said photomorphic layer and said base material.

4. The photomorphic building material of claim 3 wherein a protective layer is provided overlying said photomorphic layer, said protective layer being at least partially transparent.

5. The photomorphic building material of claim 2 wherein an image layer is provided on a side of said photomorphic layer opposite said base material.

6. The photomorphic building material of claim 2 wherein said photomorphic layer is configured as a recognizable image.

7. The photomorphic building material of claim 1 wherein said base material is at least partially transparent and said photomorphic layer is located behind said base material on a side opposite said at least one side of said base material adapted for viewing.

8. The photomorphic building material of claim 7 wherein an image layer is interposed between said photomorphic layer and said base material.

9. The photomorphic building material of claim 8 wherein an attachment layer is provided behind said photomorphic layer, said attachment layer adapted to facilitate attachment of said photomorphic building material to an installation surface.

10. The photomorphic building material of claim 7 wherein an image layer is provided on a side of said photomorphic layer opposite said building material.

11. The photomorphic building material of claim 10 wherein an attachment layer is located behind said image layer, said attachment layer adapted to facilitate attachment of said photomorphic building material to an installation surface.

12. The photomorphic building material of claim 7 wherein said photomorphic layer is configured as a recognizable image.

13. The photomorphic building material of claim 1 wherein said photomorphic layer includes a thermochromatic material adapted to change in appearance responsive to changes in temperature experienced by said photomorphic layer.

14. The photomorphic building material of claim 1 wherein said photomorphic layer includes a photochromatic material, said photochromatic material adapted to change in appearance responsive to an amount of light incident upon said photochromatic material.

15. The photomorphic building material of claim 1 wherein said photomorphic layer includes a liquid crystal material, said liquid crystal material adapted to change in appearance responsive to changes in environmental conditions taken from the group of environmental conditions including temperature changes, light changes and pressure changes.

16. A method for manufacturing a photomorphic building material, including the steps of:
coupling a photomorphic layer to a base material, the base material adapted to be installed within a residential structure, the base material having at least one side adapted to be oriented for viewing by individuals adjacent the residential structure, the photomorphic layer visible from the viewing side of the base material, the photomorphic layer adapted to change in appearance in response to changes in environmental conditions experienced by the photomorphic layer.

17. The method of claim 16 including the further step of coupling an image layer to the photomorphic building material.

18. A method for imparting a photomorphic appearance to a residential space within a residential structure, the photomorphic appearance changing responsive to environmental conditions, the method including the steps of:
providing a photomorphic building material having a base material adapted to be installed within the residential structure, the base material having at least one side adapted to be oriented for viewing by individuals adjacent the residential structure, the photomorphic layer coupled to the base material, the photomorphic layer visible from the viewing side of the base material, the photomorphic layer adapted to change in appearance in response to changes in environmental conditions experienced by the photomorphic layer;
installing the photomorphic building material upon a surface within the residential space where the photomorphic building material can be viewed; and
changing environmental conditions within the residential space that correspond with appearance change parameters of the photomorphic layer past a change threshold, such that the photomorphic layer undergoes an appearance change.

19. The method of claim 18 including the further step of selecting the surface for installation of the photomorphic building material to be a tiled wall with the base material in the form of a plurality of tiles affixed to the tiled wall.

20. The method of claim 18 wherein said providing step includes providing the base material in the form of a water containing basin adapted to be installed within the residential structure.
